(19) United States
(12) Patent Application Publication
(10) Pub. No.: US 2026/0008318 A1
(43) Pub. Date: Jan. 8, 2026

(54) HYDRAULIC MANIFOLD, HYDRAULIC UNIT AND METHOD FOR ASSEMBLING A HYDRAULIC UNIT

(71) Applicant: Robert Bosch GmbH, Stuttgart (DE)

(72) Inventor: Stephan Pauli, Achern (DE)

(21) Appl. No.: 19/262,625

(22) Filed: Jul. 8, 2025

(30) Foreign Application Priority Data
Jul. 8, 2024 (DE) 10 2024 206 394.0

(51) Int. Cl. B60H 1/00

(52) U.S. Cl. CPC B60H 1/00557

(57) ABSTRACT

A hydraulic manifold (20) is configured to receive a plurality of electrical coolant and/or refrigerant circulation components (1a-3c) and to direct coolant/refrigerant to the components (1a-3c). The hydraulic manifold (20) includes a plurality of electrical cables (55) for connecting the plurality of electrical coolant and/or refrigerant circulation components (1a-3c) to an on-board power system of a vehicle.

### BACKGROUND

The present invention relates to a hydraulic manifold and hydraulic unit for a coolant and/or refrigerant circuit of a vehicle, as well as a method of assembling a hydraulic unit.

A vehicle, particularly an electric vehicle, may include coolant circuits and refrigerant circuits, for example, to cool a traction battery of the vehicle and/or to adjust temperature in/climatize a passenger compartment. Such coolant/refrigerant circuits may include a hydraulic unit (flexible thermal unit-FTU) that compactly groups together individual components of the coolant/refrigerant circuits in a space-saving manner. For this purpose, the components can be mounted on a hydraulic manifold, for example, which distributes coolant/refrigerant among the individual components, in particular directing them towards and/or away from them.

In this regard, DE 10 2022 208 108 A1 discloses a FTU, in which a plurality of coolant pumps, a plurality of electronic expansion valves, a plurality of coolant valves, a capacitor, a battery heat exchanger and a reservoir are contained.

To connect electrical components of the FTU to an on-board power system of the vehicle, a wiring harness can be used, for example, which can comprise a customer-specific plug, in order to be able to easily install the FTU in different vehicles. However, the manufacture of such wiring harnesses is laborious and assembly of the wiring harness to the FTU must be done manually due to its flexibility, thereby incurring high costs both during manufacture and assembly of the wiring harness.

### SUMMARY

According to the invention, a hydraulic manifold and a hydraulic unit for a coolant and/or refrigerant circuit of a vehicle are proposed, as well as a method of assembling a hydraulic unit with the features of the independent claims. Advantageous embodiments are the subject of the following description.

The hydraulic manifold according to the present invention is configured to receive a plurality of electrical coolant and/or refrigerant circulation components and to direct coolant/refrigerant means to the components. It forms, along with a plurality of electrical coolant and/or refrigerant circuit components, a hydraulic unit that includes or assumes multiple functions of a coolant and/or refrigerant circuit.

According to one embodiment, the plurality of electrical coolant and/or refrigerant circulation components may comprise at least one pump and/or at least one valve and/or at least one sensor. It is also possible that one or more computing units, e.g., one or more controllers for controlling/regulating one or more coolant and/or refrigerant circuits, are attached to or contained in the hydraulic unit. For example, the at least one pump may be a coolant pump by means of which a flow of coolant may be adjusted in the coolant circuit. The at least one valve may be, for example, an electrical expansion valve of the refrigerant circuit and/or a coolant valve of the coolant circuit. By means of a coolant valve, for example, a plurality of cooling circuits of the vehicle can be selectively combined with one another to, for example, release heat simultaneously into the passenger compartment and to the traction battery. For example, the at least one sensor may be a pressure sensor, a temperature sensor, and/or a flow rate sensor of the coolant and/or refrigerant circuit.

In particular, the hydraulic unit may include components of the coolant circuit, such as coolant pumps, coolant valves, etc., and/or components of the refrigerant circuit, such as expansion valves, etc. In other words, the vehicle may include, for example, a hydraulic unit for the coolant circuit (flexible thermal unit-cooling-FTU-C) and/or a hydraulic unit for the refrigerant circuit (flexible thermal unit-refrigeration-FTU-R).

According to one embodiment, the hydraulic manifold of the hydraulic unit may be made of plastic or metal. In particular, the hydraulic manifold may be made of metal when used in the hydraulic unit for the refrigerant circuit, in which higher pressures prevail than in the coolant circuit.

The hydraulic manifold contains a plurality of electrical cables for connecting the plurality of electrical coolant and/or refrigerant circulation components to an on-board power system of the vehicle. In particular, the plurality of electrical cables of the hydraulic manifold may replace a separate wiring harness. All necessary electrical connections between the electrical components of the hydraulic manifold and the vehicle's on-board power system are thus possible in a highly automated manner. In addition, any single wire seals required when using a wiring harness are omitted and the electrical components may be connected to the electrical cables via simple contacts. In this way, a significant cost reduction can be achieved in the manufacture and assembly of the hydraulic unit.

According to one embodiment, at least one of the plurality of electrical cables may be integrated as conductor strips into the hydraulic manifold, i.e., in a material of which the hydraulic manifold consists. For example, the conductor strips may be injected into plastic parts of the hydraulic manifold.

According to one embodiment, at least one of the plurality of electrical cables may be integrated into one or more surfaces of the hydraulic manifold. To this end, for example, one or more conductor strips may be embedded/injected into the hydraulic manifold at a predetermined distance from an external surface of the hydraulic manifold.

According to another embodiment, at least one of the plurality of electrical cables may be passed through the hydraulic manifold. For example, one or more conductor strips may pass through an interior/an inner area of the hydraulic manifold instead of along or below its outer surface. As a result, shorter cables and a very compact cable arrangement can be realized compared to using a wire harness.

According to one embodiment, at least one of the plurality of electrical cables may be configured as a stamped part, i.e., a part stamped out of sheet metal and encased in plastic. The stamped part can expediently be overmolded with the plastic. If a plurality of electrical cables are configured as a stamped part, the entire stamped part can in particular be configured as a stamped grid, i.e., as individual stamped parts connected at bridges, which are then conveniently separated at the connected locations after overmolding with plastic to avoid short circuits. In other words, some or all of the cables of the plurality of electrical cables may be stamped from sheet metal, overmolded with plastic, and, where necessary, insulated from each other by cutting the bridges.

According to one embodiment, the plastic-encased stamped part may at least partially enclose the hydraulic manifold. In particular, the stamped part can be manufactured as a flat component for this purpose and subsequently brought into a spatial structure that allows the hydraulic manifold to be at least partially enclosed.

According to one embodiment, the plastic-encased stamped part may be attached to the hydraulic manifold, in particular, clipped onto said manifold. To this end, the hydraulic manifold may comprise a plurality of connection points at which the plastic-encased stamped part may be clipped on or suitably attached in other ways. A design of the plurality of electrical cables as a plastic-encased stamped part is particularly advantageous for a hydraulic manifold made of metal for a hydraulic unit of a refrigerant circuit (FTU-R).

In a method according to the present invention for assembling a hydraulic unit for a coolant and/or refrigerant circuit of a vehicle, a hydraulic manifold is provided as described above. A plurality of electrical coolant and/or refrigerant circulation components is mounted on the hydraulic manifold.

For example, one or more coolant pumps, one or more coolant valves, one or more pressure, temperature, and flow rate sensors, and/or one or more coolant circuit controllers may be mounted on a plastic hydraulic manifold for a hydraulic unit of a coolant circuit (FTU-C). Accordingly, for example, one or more expansion valves, one or more pressure, temperature and flow rate sensors and/or one or more controllers for the refrigerant circuit may be mounted on a hydraulic manifold made from metal for a hydraulic unit of a refrigerant circuit (FTU-R).

The plurality of electrical coolant and/or refrigerant circulation components are then connected to an on-board power system of the vehicle by means of a plurality of electrical cables contained in/on the hydraulic manifold.

The method described above can in particular be carried out in a (highly) automated manner. All steps of the method may be carried out, e.g., by a machine, a robot, or the like, without the need for manual actions.

According to one embodiment of the method, e.g., after the installation/assembly of the plurality of electrical components, a stamped part at least partially encased in plastic comprising the plurality of electrical cables may be attached to the hydraulic manifold. This may be the case in particular if the hydraulic manifold is made of metal and does not contain plastic parts with embedded electrical cables. However, it is also possible for a stamped part, which is at least partially encased in plastic, to be attached to a hydraulic manifold with injected conductor strips in order to provide additional electrical cables. The plastic-encased stamped part can be attached to the hydraulic manifold in such a way that it at least partially encloses the same. In this way, a compact arrangement of the electrical cables can be achieved. The attachment of the stamped part can in particular be by means of clips, which can be clipped on at corresponding connection points of the hydraulic manifold. The assembly of the stamped part can also be (highly) automated due to its stiffness.

### BRIEF DESCRIPTION OF THE DRAWINGS

Further advantages and embodiments of the invention are evident from the description of the accompanying drawings.

The invention is illustrated schematically in the drawings on the basis of exemplary embodiments and is described in the following with reference to said drawings. Like or similar elements are provided with identical reference numerals in the drawings and are therefore not described more than once unless necessary.

FIG. 1 schematically shows a hydraulic unit not according to the invention with a cable harness.

FIG. 2 schematically shows components of a hydraulic unit connected to a controller via a plurality of electrical cables.

FIGS. 3a and 3b schematically show a plastic-encased stamped part in a top view and in a side view comprising a plurality of electrical cables, and which can be used on a hydraulic unit according to the invention.

FIG. 4 shows a stamped part similar to that of FIGS. 3a and 3b in a mounted state on a hydraulic unit in a top view.

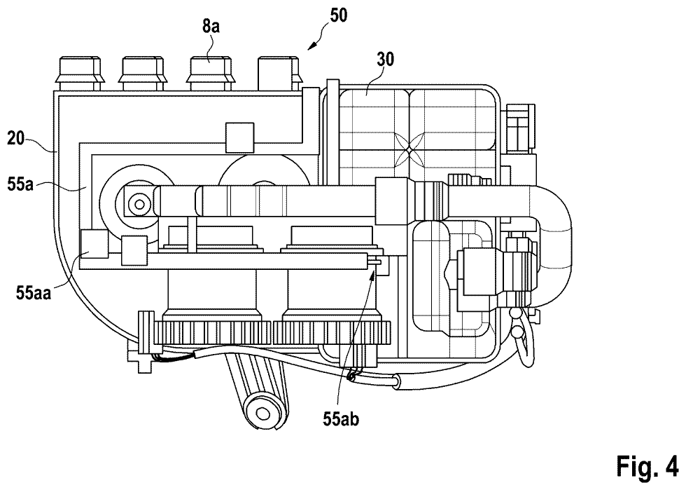

### DETAILED DESCRIPTION

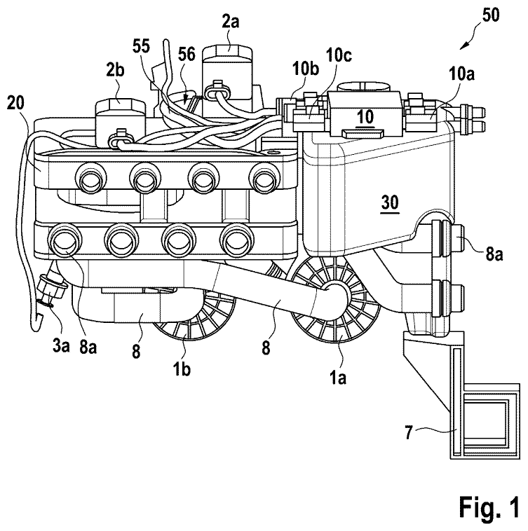

FIG. 1 schematically shows a hydraulic unit 50 not according to the invention for one or more coolant circuits (FTU-C), the electrical components 1a-3a of which are connected to a controller 10 by means of a wiring harness 56. The hydraulic unit 50 is configured to compactly combine the individual components 1a-3a or to integrate them into a device/module in a space-saving manner.

The hydraulic unit 50 includes a hydraulic manifold 20 having a plurality of hydraulic connections 8a, to which coolant lines of one or more coolant circuits of a vehicle (not shown) may be connected.

Two coolant pumps 1a, 1b are attached to the hydraulic manifold 20, from each of which a coolant pipe 8 branches off. A pressure sensor 3a is mounted in one of the coolant pipes 8 that determines a pressure of the coolant in a coolant circuit (not shown) supplied by the coolant pump 1a. Two coolant valves 2a, 2b are arranged on a top side of the hydraulic manifold 20, by means of which, for example, a plurality of coolant circuits can be connected to one another.

A coolant reservoir 30 is attached to an end face of the hydraulic unit 50, on top of which a controller 10 having a plurality of connectors 10a-10c is located/attached for controlling/regulating the coolant circuits of the vehicle.

A plug 10a, which is arranged on an externally facing side of the controller 10, is used to electrically connect the controller 10 to a vehicle controller (not shown) or an on-board power supply of the vehicle.

By means of two plugs 10b, 10c located on an opposite side of the controller 10, the electrical components 1a-3a of the hydraulic unit 50 are connected to the controller 30 via the wiring harness 56. To this end, the wiring harness 56 comprises a plurality of electrical cables 55. In particular, the coolant valves 2a, 2b are connected to the controller 30 via the plug 10b and the coolant pumps via the plug 10c.

Beneath the coolant reservoir 30 is a holder 7 that allows the hydraulic unit 50 to be attached to, for example, a body of the vehicle.

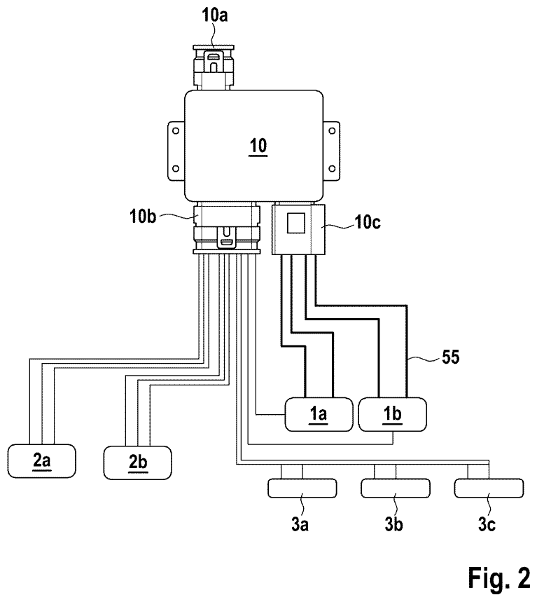

FIG. 2 schematically shows components 1a-3a of a hydraulic unit 50 connected to a controller 10 by means of a plurality of electrical cables 55. On one side, the controller 10 in turn comprises the plug 10a, to which the vehicle controller or the vehicle's on-board power supply can be connected. On an opposite side of the controller 10, the plug 10b for electrically connecting the coolant valves 2a, 2b and the plug 10c for electrically connecting the coolant pumps are located. Via the plug 10a, a plurality of sensors 3a-3c are also connected to the controller 10. Between the electrical components 1a-3c and the plugs 10b, 10c, a plurality of electrical cables 55 is attached, which, according to an embodiment of the present invention, may, for example, be integrated as conductor strips into the hydraulic manifold 20. For example, the conductor strips may be injected into plastic parts of the hydraulic manifold 20. For example, one or more conductor strips may be embedded/injected into the hydraulic manifold at a predetermined distance from an external surface of the hydraulic manifold 20. It is also possible for one or more conductor strips to pass through an interior/an inner area of the hydraulic manifold 20, rather than along or below its outer surface. As a result, shorter cables and a very compact cable arrangement can be realized compared to using a wire harness.

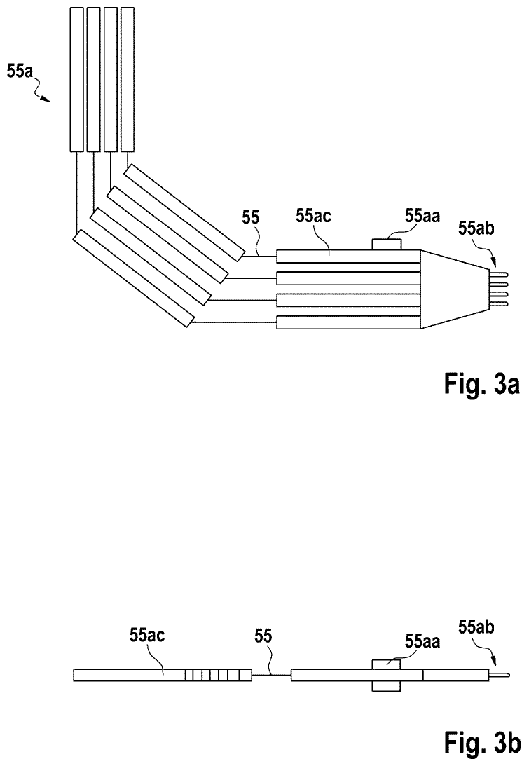

FIGS. 3a and 3b schematically show a partially plastic-encased stamped part 55a comprising a plurality of electrical cables 55 (and thus may also be referred to as a stamped grid) and may be used on a hydraulic unit 50 according to the invention. The stamped part 55a provides an alternative to the embedding/injection of the conductor strips in the hydraulic manifold 20 and can be arranged on its outer sides/surfaces. Expediently, the stamped part may be at least partially overmolded with plastic 55ac.

In particular, FIG. 3a shows the stamped part 55a in a top view and FIG. 3b shows the stamped part 55a in a side view. In the present case, the stamped part 55a contains four electrical cables 55 partially surrounded by a plastic covering/plastic overmolding 55ac. The stamped part 55a has a flat shape and is shaped as per requirements. In the present example, it has two bends that together give about a 90° bend. Some flexibility and tolerance are given by areas of the stamped part that remain free of plastic. It can also be provided that the stamped part is first brought into the desired shape and then overmolded in its entirety, which, however, places significantly higher requirements on tolerances. It can further be provided that the plastic areas shown separately in the figure are connected to one another in whole or in part by plastic bridges or the like.

The electrical cables 55, particularly if they remain free of a plastic covering/plastic overmolding 55ac, may be covered, coated or rubberized for insulation.

A plug 55ab is attached to a face of the stamped part 55a, e.g., a conventional plug, the contact elements of which are connected to the cables 55 of the stamped part 55a. Stamped part 55a may comprise a plurality of further plugs in addition to the plug 55ab shown.

An exemplary clip 55aa is attached to one side of the stamped part 55a, with which the stamped part can be clipped onto the hydraulic unit 50, in particular to the hydraulic manifold (see FIG. 3c). To this end, the hydraulic manifold 20 may comprise a plurality of connection points (not shown) at which the plastic-encased stamped part may be clipped on or suitably attached in other ways.

The stamped part 55a is not limited to four electrical cables 55, but can comprise a plurality of electrical cables, which can also be branched to one another. The electrical cables 55 may be configured as stamped pieces, conductor strips or as wires. When using wires, a use of tension clamp connections between the components to be contacted and the plastic overmolded stamped part is advantageous.

FIG. 3c shows a stamped part 55a, such as that of FIGS. 3a and 3b, in the assembled state on a hydraulic unit 50. In the present case, the hydraulic unit 50 is shown in a bottom view and the stamped part 55a is mounted to a bottom side of the hydraulic manifold 20 to partially enclose it. For this purpose, the stamped part 55a shown in FIGS. 3a and 3b was bent at several locations by 90° to a previous stamped part section. In the present case, the stamped part is attached to a surface of the hydraulic manifold 20 with three clips. It is also possible for the stamped part 55a to at least partially enclose the bottom side and/or the top side of the hydraulic unit.

A design of the plurality of electrical cables 55 as a plastic-encased stamped part 55a is particularly advantageous for a metal hydraulic manifold 20 for a hydraulic unit 50 of a refrigerant circuit (FTU-R). However, the stamped part 55a can also be used with a plastic manifold 20, as in the present case. In that case, for example, electrical cables and cables introduced into the plastic of hydraulic manifold 20 may be supplemented by clipped stamped parts 55a.

It is understood that the features of the various embodiments explained herein as an example can not only be used in the specific combination described herein, but can also be combined or used alone.

1. A hydraulic manifold (20) for a coolant and/or refrigerant circuit of a vehicle configured to receive a plurality of electrical coolant and/or refrigerant circuit components (1a-3c) and to direct coolant/refrigerant to the components (1a-3c), wherein
the hydraulic manifold (20) comprises a plurality of electrical cables (55) for connecting the plurality of electrical coolant and/or refrigerant circulation components (1a-3c) to an on-board power supply of the vehicle.

2. The hydraulic manifold (20) according to claim 1, wherein at least one cable of the plurality of electrical cables (55) is integrated as a conductor strip into the hydraulic manifold (20).

3. The hydraulic manifold (20) according to claim 1, wherein at least one cable of the plurality of electrical cables (55) is integrated into one or more surfaces of the hydraulic manifold (20).

4. The hydraulic manifold (20) according to claim 1, wherein at least one cable of the plurality of electrical cables (55) is passed through the hydraulic manifold (20).

5. The hydraulic manifold (20) according to claim 1, wherein at least one cable of the plurality of electrical cables (55) is configured as a stamped part (55a) and is at least partially encased in a plastic.

6. The hydraulic manifold (20) according to claim 5, wherein the plastic-encased stamped part (55a) at least partially encloses the hydraulic manifold (20).

7. The hydraulic manifold (20) according to claim 5, wherein the plastic-encased stamped part (55a) is attached to the hydraulic manifold (20).

8. The hydraulic manifold (20) according to claim 1, wherein the manifold is made of plastic or metal.

9. A hydraulic unit (50) for a coolant and/or refrigerant circuit of a vehicle comprising a plurality of electrical coolant and/or refrigerant circuit components (1a-3c) and the hydraulic manifold (20) according to claim 1.

10. The hydraulic unit (50) according to claim 9, wherein the plurality of electrical coolant and/or refrigerant circulation components (1a-3c) comprises at least one pump (1a, 1b) and/or at least one valve (2a, 2b) and/or at least one sensor (3a-3c).

11. A method of assembling a hydraulic unit (50) for a coolant and/or refrigerant circuit of a vehicle, comprising the steps of:
providing a hydraulic manifold (20);
attaching a plurality of electrical coolant and/or refrigerant circulation components (1a-3c) to the hydraulic manifold (20);
connecting the plurality of electrical coolant and/or refrigerant circulation components (1a-3c) to an on-board power supply of the vehicle by a plurality of electrical cables (55) on the hydraulic manifold (20).

12. The method according to claim 11, further comprising:
attaching a plastic-encased stamped part (55a) comprising at least one cable of the plurality of electrical cables (55) to the hydraulic manifold (20).

13. The method according to claim 12, wherein attaching the plastic-encased stamped part (55a) comprising at least one cable of the plurality of electrical cables (55) to the hydraulic manifold (20) includes clipping the plastic-encased stamped part (55a) to the hydraulic manifold (20).

14. The hydraulic manifold (20) according to claim 7, wherein the plastic-encased stamped part (55a) is attached to the hydraulic manifold (20) by a clip.
